(19) United States
(12) Patent Application Publication
(10) Pub. No.: US 2026/0299491 A1
(43) Pub. Date: Oct. 1, 2026

(54) RECORDING MEDIUM ACCOMMODATING DEVICE AND IMAGE FORMING APPARATUS

(71) Applicant: FUJIFILM Business Innovation Corp., Tokyo (JP)

(72) Inventor: Yuichi ARAKI, Kanagawa (JP)

(73) Assignee: FUJIFILM Business Innovation Corp., Tokyo (JP)

(21) Appl. No.: 19/271,723

(22) Filed: Jul. 16, 2025

(30) Foreign Application Priority Data
Mar. 26, 2025 (JP) 2025-052443

(51) Int. Cl. G03G 15/00; B65H 3/12; B65H 3/48

(52) U.S. Cl. CPC G03G 15/6558; B65H 3/128; B65H 3/48; B65H 2220/01; B65H 2511/22; B65H 2513/512; B65H 2553/42; G03G 2215/00396

(57) ABSTRACT

A recording medium accommodating device includes a feeder configured to feed out a recording medium included in recording media to be loaded, a gas blower configured to perform gas blowing onto the recording medium in accordance with a predetermined setting in a case where feeding out of the recording medium is performed, and a processor configured to cause a decision process to be performed before the feeding out of the recording medium is started, the decision process being a process for deciding on a content of the setting, in which the recording medium accommodating device is configured to change a start timing that is a timing for starting the decision process.

### CROSS-REFERENCE TO RELATED APPLICATIONS

This application is based on and claims priority under 35 USC 119 from Japanese Patent Application No. 2025-052443 filed Mar. 26, 2025.

### BACKGROUND

### (i) Technical Field

The present disclosure relates to a recording medium accommodating device and an image forming apparatus.

### (ii) Related Art

JP6347066B discloses an image forming apparatus including a loading portion on which a sheet bundle formed by stacking a plurality of sheets in an up-down direction is loaded, and a conveying unit that is provided above the loading portion and that adsorbs an uppermost sheet and conveys the sheet in a conveyance direction.

### SUMMARY

In a device having a function of accommodating a recording medium, gas blowing may be performed onto the recording medium. Additionally, it is also assumed that the blowing is performed after a decision process that is a process for deciding on a content of a setting related to the blowing has been performed.

Here, for example, in a case where a start timing for the decision process is uniformly set to be after an instruction to start conveying the recording medium has been issued, a time required until the conveyance of the recording medium is started becomes longer.

In this case, the satisfaction of a user who expects an early start of conveyance of the recording medium tends to decrease.

In addition, in a case where the start timing for the decision process is before the instruction to start conveying the recording medium is issued, user satisfaction may decrease.

In a case where the start timing for the decision process is before the instruction to start conveying the recording medium is issued, an idle time is likely to occur between the end of the decision process and the actual start of conveyance of the recording medium.

In this case, a state of the recording medium in a case where the decision process is performed and a state of the recording medium in a case where the conveyance of the recording medium is actually started are likely to differ. Consequently, the conveyance of the recording medium is likely to deviate from the intended conveyance. In this case, the satisfaction of the user who requires high conveyance performance of the recording medium tends to decrease.

Aspects of non-limiting embodiments of the present disclosure relate to a recording medium accommodating device and an image forming apparatus that enhance user satisfaction related to conveyance of a recording medium, as compared with a configuration in which a start timing for a decision process that is a process for deciding on a content of a setting related to gas blowing onto the recording medium cannot be changed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a recording medium accommodating device including: a feeder configured to feed out a recording medium included in recording media to be loaded; a gas blower configured to perform gas blowing onto the recording medium in accordance with a predetermined setting in a case where feeding out of the recording medium is performed; and a processor configured to cause a decision process to be performed before the feeding out of the recording medium is started, the decision process being a process for deciding on a content of the setting, in which the recording medium accommodating device is configured to change a start timing that is a timing for starting the decision process.

### BRIEF DESCRIPTION OF THE DRAWINGS

Exemplary embodiment(s) of the present invention will be described in detail based on the following figures, wherein:

FIG. 1 is a diagram showing an image forming apparatus;

FIG. 2 is a diagram showing an example of a hardware configuration of a control unit;

FIG. 3 is a perspective view of a paper accommodating device as viewed from a front side of the image forming apparatus;

FIG. 4 is a view of the paper accommodating device as viewed in a direction indicated by an arrow IV in FIG. 3;

FIG. 5 is a flowchart showing an example of a flow of the above-described decision process of deciding on a blowing setting;

FIG. 6 is a diagram showing an example of a state transition of the image forming apparatus;

FIG. 7 is a diagram showing a display example of a receiving unit; and

FIG. 8 is a diagram showing another configuration example of the image forming apparatus.

### DETAILED DESCRIPTION

Hereinafter, exemplary embodiments of the present disclosure will be described with reference to the accompanying drawings.

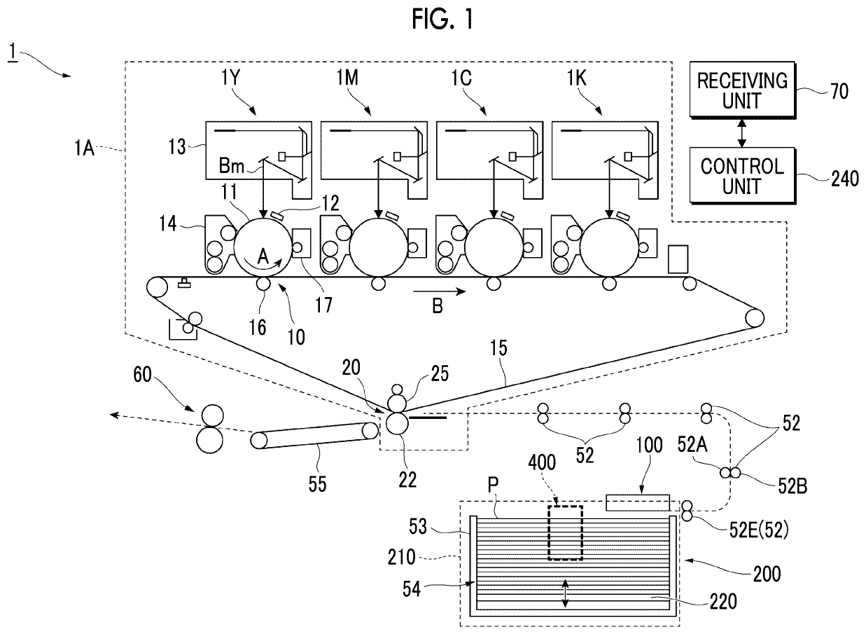

FIG. 1 is a diagram showing an image forming apparatus 1 according to the present exemplary embodiment.

The image forming apparatus 1 shown in FIG. 1 is an image forming apparatus of an intermediate transfer type called a tandem type. The image forming apparatus 1 is provided with a paper accommodating device 200 that accommodates paper P, which is an example of a recording medium.

Additionally, the image forming apparatus 1 is provided with an image forming section 1A. The image forming section 1A forms an image on the paper P fed out from the paper accommodating device 200.

The image forming section 1A is provided with a plurality of image forming units 1Y, 1M, 1C, and 1K. Each of the plurality of image forming units 1Y, 1M, 1C, and 1K forms a toner image of a corresponding color component by using an electrophotographic method.

Additionally, the image forming section 1A is provided with a primary transfer unit 10. The toner images of respective colors formed by the image forming units 1Y, 1M, 1C, and 1K are transferred onto an intermediate transfer belt 15 by the primary transfer unit 10.

Further, the image forming section 1A is provided with a secondary transfer unit 20. The toner images transferred onto the intermediate transfer belt 15 are transferred onto the paper P by the secondary transfer unit 20.

In addition, the image forming apparatus 1 is provided with a fixing device 60 that fixes the toner image secondarily transferred onto the paper P to the paper P.

The image forming apparatus 1 is further provided with a control unit 240 that controls an operation of each unit of the image forming apparatus 1. Additionally, the image forming apparatus 1 is provided with a receiving unit 70 that receives information input by a user.

The receiving unit 70 is configured, for example, by a touch panel. The receiving unit 70 has, in addition to a reception function of receiving information from the user, a display function of displaying the information.

A device for implementing the reception function and a device for implementing the display function may be individually provided.

### Configuration of Control Unit 240

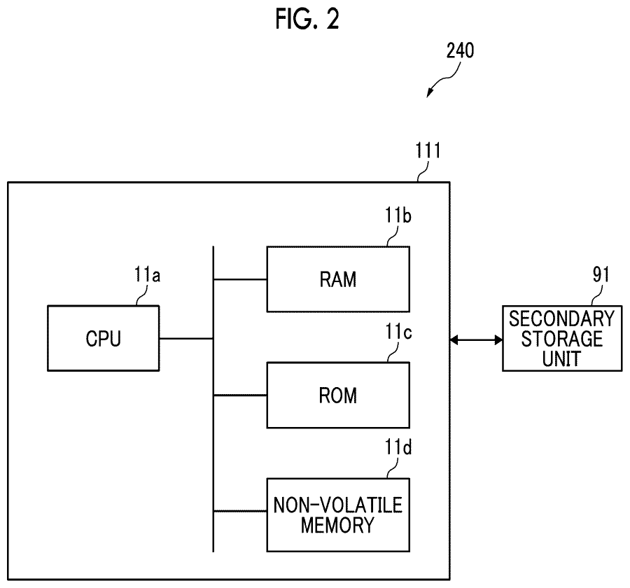

FIG. 2 is a diagram showing an example of a hardware configuration of the control unit 240. The control unit 240 is implemented by a computer.

The control unit 240 includes a computation processing unit 111 that executes digital computation processing in accordance with a program, and a secondary storage unit 91 that stores information.

The secondary storage unit 91 is implemented, for example, by an existing information storage device, such as a hard disk drive (HDD), a semiconductor memory, or a magnetic tape.

The computation processing unit 111 is provided with a CPU 11a as an example of a processor.

In addition, the computation processing unit 111 is provided with a RAM 11b that is used as a work memory or the like of the CPU 11a. The computation processing unit 111 is further provided with a ROM 11c that stores a program and the like executed by the CPU 11a.

Furthermore, the computation processing unit 111 is provided with a non-volatile memory 11d that can retain data even in a case where power supply is interrupted.

The non-volatile memory 11d is configured, for example, as a battery-backed SRAM, a flash memory, or the like. The secondary storage unit 91 stores various kinds of information, such as a program executed by the computation processing unit 111.

In the present exemplary embodiment, the CPU 11a of the computation processing unit 111 reads the program stored in the ROM 11c or the secondary storage unit 91. The CPU 11a executes the program stored in the ROM 11c or the secondary storage unit 91. Consequently, various kinds of processing performed by the image forming apparatus 1 are executed. Various kinds of processing performed by the image forming apparatus 1 are executed by the CPU 11a.

The program executed by the CPU 11a may be provided to the image forming apparatus 1 via a recording medium.

An example of the recording medium includes a magnetic recording medium, such as a magnetic tape or a magnetic disk. In addition, another example of the recording medium includes an optical recording medium, such as an optical disc.

Further, still another example of the recording medium includes a magneto-optical recording medium. Furthermore, still another example of the recording medium includes a semiconductor memory or the like.

Additionally, the program executed by the CPU 11a may be provided to the image forming apparatus 1 by using communication means such as the Internet.

With reference to FIG. 1, the image forming apparatus 1 will be further described.

The following devices are installed in each of the image forming units 1Y, 1M, 1C, and 1K.

First, a photosensitive drum 11 that rotates in a direction of an arrow A is provided. A charger 12 that charges the photosensitive drum 11 is provided around the photosensitive drum 11. An exposure device 13 that forms an electrostatic latent image on the photosensitive drum 11 is further provided. Furthermore, a developing unit 14 that develops the electrostatic latent image on the photosensitive drum 11 with a toner is provided.

Additionally, each of the image forming units 1Y, 1M, 1C, and 1K is provided with a primary transfer roller 16. The primary transfer roller 16 is provided in the primary transfer unit 10. The toner image formed on the photosensitive drum 11 is transferred onto the intermediate transfer belt 15 by the primary transfer roller 16.

Further, each of the image forming units 1Y, 1M, 1C, and 1K is provided with a drum cleaner 17. The drum cleaner 17 removes residual toner and the like remaining on the photosensitive drum 11.

The intermediate transfer belt 15 circulates in a direction of an arrow B shown in FIG. 1 at a predetermined speed.

The primary transfer unit 10 includes the primary transfer roller 16 that is disposed to face the photosensitive drum 11 with the intermediate transfer belt 15 sandwiched therebetween.

In the present exemplary embodiment, the toner images on the respective photosensitive drums 11 are sequentially electrostatically attracted onto the intermediate transfer belt 15. Consequently, a superimposed toner image is formed on the intermediate transfer belt 15.

The secondary transfer unit 20 includes a secondary transfer roller 22 that is disposed to face an outer peripheral surface of the intermediate transfer belt 15, and a backup roller 25.

The secondary transfer roller 22 is pressed against the backup roller 25 with the intermediate transfer belt 15 sandwiched therebetween. A voltage is applied between the secondary transfer roller 22 and the backup roller 25. In the present exemplary embodiment, the toner image on the intermediate transfer belt 15 is transferred onto the paper P conveyed to the secondary transfer unit 20.

In the present exemplary embodiment, the paper P fed out from the paper accommodating device 200 is conveyed to the secondary transfer unit 20. The toner image on the intermediate transfer belt 15 is transferred onto the paper P fed out from the paper accommodating device 200.

In the present exemplary embodiment, image data is output to the image forming apparatus 1 from an image scan device (not shown), a personal computer (PC), or the like.

Then, image processing is performed on the image data by an image processing device (not shown). Consequently, image data of four colors Y, M, C, and K is generated. The generated image data is output to the exposure device 13 provided for each of the colors Y, M, C, and K.

The exposure device 13 irradiates the photosensitive drum 11 with light in response to the input image data.

For exposure of the photosensitive drum 11 by the exposure device 13, for example, a semiconductor laser is used. In addition, for exposure of the photosensitive drum 11 by the exposure device 13, for example, a light emitting diode (LED) is used.

In each of the photosensitive drums 11, a surface is charged by the charger 12. Thereafter, the surface is subjected to scanning exposure by the exposure device 13, and an electrostatic latent image is formed on the surface.

Next, toner is attached to the photosensitive drum 11 by the developing unit 14. Consequently, a toner image is formed on the photosensitive drum 11.

The toner image formed on the photosensitive drum 11 is transferred onto the intermediate transfer belt 15 by the primary transfer unit 10.

After this toner image is transferred onto a surface of the intermediate transfer belt 15, the toner image is moved to the secondary transfer unit 20 by the moving intermediate transfer belt 15.

In the secondary transfer unit 20, the secondary transfer roller 22 is pressed against the backup roller 25 via the intermediate transfer belt 15.

In the present exemplary embodiment, the paper P fed out from the paper accommodating device 200 is sandwiched between the intermediate transfer belt 15 and the secondary transfer roller 22.

Consequently, an unfixed toner image held on the intermediate transfer belt 15 is transferred onto the paper P by the secondary transfer unit 20. Thereafter, the paper P onto which the toner image has been transferred is discharged to a paper discharge section (not shown) after passing through the fixing device 60.

### Description of Paper Accommodating Device

The paper accommodating device 200 as an example of a recording medium accommodating device is provided with an accommodating section 53 that accommodates the paper P to be loaded.

The accommodating section 53 is provided with a support base 220 that supports the paper P to be loaded from below.

In a case where the paper P is set in the paper accommodating device 200, first, an opening and closing member 210 functioning as a lid is opened. The opening and closing member 210 is opened by rotating about a hinge (not shown) extending along a vertical direction.

Thereafter, the paper P is placed on the support base 220 by the user. Next, the opening and closing member 210 is closed. In the present exemplary embodiment, the support base 220 rises in response to this closing.

In a case where the support base 220 rises, the paper P on the support base 220 approaches a suction unit 100. In the present exemplary embodiment, the uppermost paper P among sheets of paper P accommodated in the paper accommodating device 200 is fed out by the suction unit 100.

The accommodating section 53 is provided with a side guide against which a side edge of the paper P is abutted and which is used to position the paper P, or the like.

The opening and closing member 210 may be integrated with the accommodating section 53. In this case, for example, the opening and closing member 210 is attached to the accommodating section 53 as an exterior cover.

In this case, in a case where the accommodating section 53 is pulled out from the image forming apparatus 1, the opening and closing member 210 moves together with the accommodating section 53. As a result, the opening and closing member 210 is opened.

In the present exemplary embodiment, a paper bundle 54 is composed of a plurality of sheets of paper P loaded in the paper accommodating device 200. The uppermost paper P among sheets of paper P included in the paper bundle 54 is fed out.

Then, the toner image formed by the image forming section 1A is transferred onto the paper P that has been fed out, by the secondary transfer unit 20.

The paper accommodating device 200 is further provided with a blowing device 400 that blows gas onto the paper P loaded in the paper accommodating device 200.

Additionally, although not shown in FIG. 1, the paper accommodating device 200 is provided with a light source 600 that irradiates the paper P with light. Further, the paper accommodating device 200 is provided with an imaging unit 500 that images the paper P. The light source 600 and the imaging unit 500 will be described below.

In the present exemplary embodiment, gas blowing is performed onto the loaded paper P by the blowing device 400 as an example of a gas blower. In the present exemplary embodiment, gas blowing onto the paper P is performed from a lateral side of the loaded paper P.

Consequently, the paper P is floated. In addition, gas enters between the sheets of paper P.

In a case where gas enters between the sheets of paper P, adhesion between the sheets of paper P is released. In this case, so-called double feeding, in which sheets of paper P are fed out in a state in which a plurality of sheets of paper P overlap each other, is less likely to occur.

In the present exemplary embodiment, the blowing device 400 is provided on both a front side and a back side of the paper bundle 54 shown in FIG. 1. In the present exemplary embodiment, gas blowing is performed onto the paper P from both the front side and the back side. The blowing device 400 may be provided only on one side of the front side or the back side.

In the present exemplary embodiment, as the gas, air is blown. Note that the type of gas is not particularly limited. Gas other than air may be blown onto the paper P.

Additionally, the paper accommodating device 200 may be provided with a heater serving as a heat source. In this case, heated gas is blown onto the loaded paper P.

In addition, in the present exemplary embodiment, the suction unit 100 that sucks the sheets of paper P constituting the paper bundle 54 is provided above the paper bundle 54.

Further, a plurality of conveyance rollers 52 that convey the paper P fed out from the paper accommodating device 200 are provided. The conveyance rollers 52 are provided downstream of the paper accommodating device 200 in a conveyance direction of the paper P.

In the present exemplary embodiment, the feeding out of the paper P is performed from the paper accommodating device 200 by the suction unit 100. The paper P fed out from the paper accommodating device 200 is first conveyed by a most upstream conveyance roller 52E.

The term “most upstream conveyance roller 52E” refers to a conveyance roller 52 that is located most upstream in the conveyance direction of the paper P among the plurality of conveyance rollers 52.

Then, the paper P is further conveyed by another conveyance roller 52 located downstream of the most upstream conveyance roller 52E. Consequently, the paper P is directed to the secondary transfer unit 20 and the fixing device 60.

A conveyance belt 55 is further provided downstream of the secondary transfer unit 20 in the conveyance direction of the paper P. The conveyance belt 55 conveys the paper P on which the secondary transfer has been performed to the fixing device 60.

The suction unit 100 as an example of a feeder feeds out the paper P loaded in the paper accommodating device 200 toward the most upstream conveyance roller 52E.

The suction unit 100 sucks and holds the uppermost paper P among the sheets of paper P loaded in the paper accommodating device 200.

Then, the suction unit 100 moves toward the most upstream conveyance roller 52E in a state of holding the paper P. Consequently, the feeding out of the paper P included in the loaded sheets of paper P is performed. Specifically, the feeding out of the uppermost paper P among the loaded sheets of paper P is performed.

The paper P fed out by the suction unit 100 is delivered to the most upstream conveyance roller 52E. In the present exemplary embodiment, the paper P is delivered from the suction unit 100 to the most upstream conveyance roller 52E.

Consequently, the conveyance of the paper P is started by the most upstream conveyance roller 52E.

The suction unit 100 moves in a direction away from the most upstream conveyance roller 52E after delivering the paper P to the most upstream conveyance roller 52E. As a result, the suction unit 100 returns to an initial position.

In the present exemplary embodiment, in a case where the feeding out of the paper P is performed, a gas blowing function unit composed of the blowing device 400 and the CPU 11a shown in FIG. 2 performs gas blowing onto the paper P in accordance with a predetermined setting.

Consequently, the paper P is floated. The suction unit 100 feeds out the uppermost paper P among the floating sheets of paper P.

In the present specification, hereinafter, the above-described predetermined setting followed by the gas blowing function unit will be referred to as a “blowing setting”.

In the present exemplary embodiment, the CPU 11a as an example of a processor performs a decision process, which is a process for deciding on a content of the above-described blowing setting, before the feeding out of the paper P is started. The CPU 11a outputs a signal for causing the decision process to be performed, thereby causing the decision process to be performed.

More specifically, the CPU 11a causes the decision process to be performed before the image formation on the paper P is started.

In other words, the CPU 11a causes the decision process to be performed before the image formation on the paper P, which is initiated by input of a print job to the image forming apparatus 1, is started.

Consequently, the decision process is performed before the feeding out of the paper P is started. In other words, the decision process is performed before the image formation on the paper P, which is initiated by the input of the print job, is started.

The image forming apparatus 1 of the present exemplary embodiment is configured to change a start timing which is a timing for starting the decision process.

In the present exemplary embodiment, the decision process is started at least after the opening and closing member 210 has been closed.

In the present exemplary embodiment, the user can set, as the start timing, any timing after the opening and closing member 210 has been closed.

The user can set a new start timing. In a case where the user sets a new start timing, the start timing is changed.

In a case where the start timing is changed, the CPU 11a outputs a signal for issuing an instruction to start the decision process such that the decision process is started at the changed start timing.

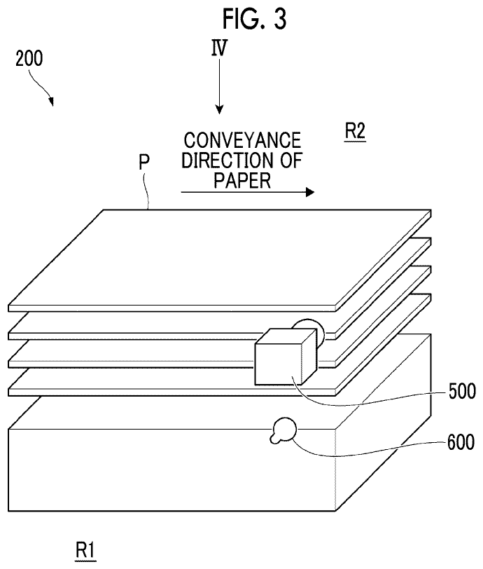

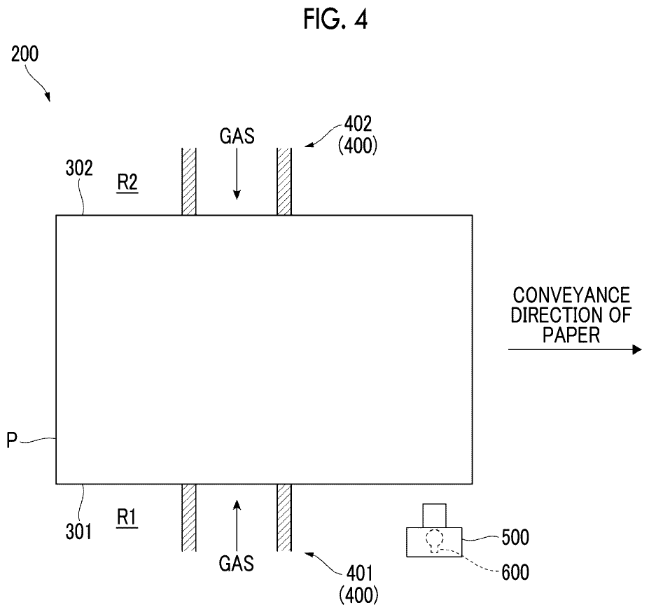

FIG. 3 is a perspective view of the paper accommodating device 200 as viewed from a front side of the image forming apparatus 1. FIG. 4 is a view of the paper accommodating device 200 as viewed in a direction indicated by an arrow IV in FIG. 3. In other words, FIG. 4 is a top view of the paper accommodating device 200.

FIG. 3 shows a state in which gas blowing is being performed by the blowing device 400. The blowing device 400 is not shown in FIG. 3.

Meanwhile, in FIG. 4, the blowing device 400 is displayed.

As shown in FIG. 4, in the present exemplary embodiment, a one-side blowing device 401 and the other-side blowing device 402 are provided as the blowing devices 400.

The one-side blowing device 401 is provided on one lateral side R1 of the paper P. Additionally, the other-side blowing device 402 is provided on the other lateral side R2 of the paper P.

In the present exemplary embodiment, as shown in FIG. 3, the imaging unit 500 that images the paper P is further provided. The imaging unit 500 is a so-called camera. The imaging unit 500 is configured, for example, by a CCD or a CMOS.

The imaging unit 500 is provided on the one lateral side R1.

As shown in FIG. 3, the light source 600 is further provided on the one lateral side R1. The light source 600 irradiates the paper P, which is to be imaged by the imaging unit 500, with light.

In the present exemplary embodiment, in a case where the paper P is imaged by the imaging unit 500, the light source 600 is turned on.

The installation location of each of the imaging unit 500 and the light source 600 is not particularly limited, and the imaging unit 500 and the light source 600 may be provided on the other lateral side R2 of the paper P. In addition, a plurality of imaging units 500 and a plurality of light sources 600 may be provided.

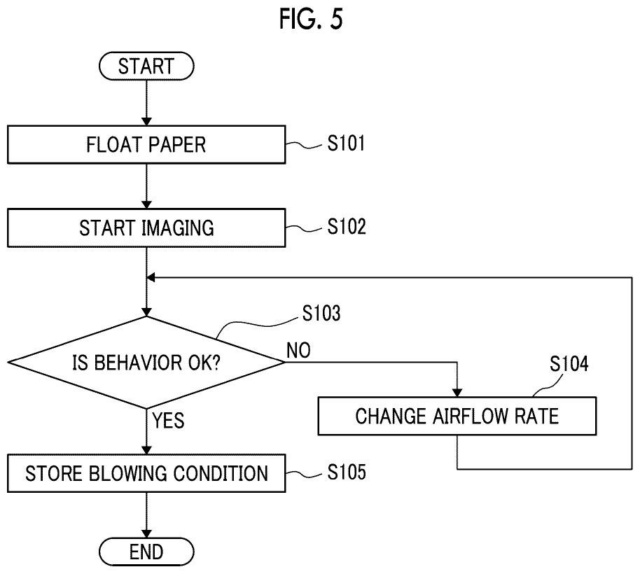

FIG. 5 is a flowchart showing an example of a flow of the above-described decision process of deciding on the blowing setting.

In the present exemplary embodiment, in a case where the start timing for the decision process is reached, the decision process is started.

In a case where the decision process is started, first, the CPU 11a performs processing of floating the paper P (step S101). The CPU 11a operates the blowing device 400 to float the paper P.

In the decision process, first, gas blowing is performed onto the paper P by the blowing device 400 which is the gas blower. As a result, the paper P is floated.

In the present exemplary embodiment, as described above, the start timing may be changed. In a case where the start timing is changed, the start timing for the gas blowing onto the paper P by the blowing device 400 is also changed accordingly.

The decision process includes, as a part of the process, a gas blowing process onto the paper P.

In a case where the start timing for the decision process is changed, the start timing for the blowing process is also changed accordingly.

After the processing of step S101, the CPU 11a starts the imaging by the imaging unit (step S102). In this case, the CPU 11a turns on the light source 600 as described above.

The paper P in a floating state is imaged by the imaging unit 500.

Next, the CPU 11a determines a behavior of the paper P (step S103). The CPU 11a determines the behavior of the paper P based on the captured image obtained by the imaging unit 500.

Then, in a case where the CPU 11a determines that the behavior of the paper P does not satisfy a predetermined condition, the CPU 11a changes the airflow rate of the gas to be blown by the blowing device 400 (step S104). Then, the CPU 11a determines the behavior of the paper P again in step S103.

In a case where the CPU 11a determines that the behavior of the paper P satisfies the predetermined condition in step S103, the process proceeds to step S105.

In step S105, the CPU 11a stores the blowing condition in the secondary storage unit shown in FIG. 2.

Specifically, the CPU 11a stores the blowing condition in a case where the behavior of the paper P satisfies the above-described predetermined condition in the secondary storage unit 91.

In the present exemplary embodiment, the blowing condition stored in the secondary storage unit 91 corresponds to the above-described blowing setting.

In step S105, the CPU 11a stores the blowing setting obtained by performing the decision process in the secondary storage unit 91.

As a result, the decision process, which is a process for deciding on the content of the blowing setting, ends.

In the present exemplary embodiment, after the decision process has ended, the gas blowing by the blowing device 400 temporarily ends.

The processing of steps S101 to S105 is performed in a preparation stage before the image formation on the paper P is started. In other words, the processing of steps S101 to S105 is performed before the feeding out of the paper P from the paper accommodating device 200 is started.

In a case where the input of the print job is performed to the image forming apparatus 1 after the decision process, the image formation on the paper P is started.

In a case where the input of the print job is performed, the CPU 11a reads and acquires the above-described blowing setting stored in the secondary storage unit 91.

Then, the CPU 11a controls the blowing device 400 based on the blowing setting.

In this case, the blowing device 400 operates in accordance with the blowing setting obtained by the above-described decision process. In a case where the print job has been input, the blowing device 400 performs gas blowing onto the paper P in accordance with the blowing setting which is a predetermined setting.

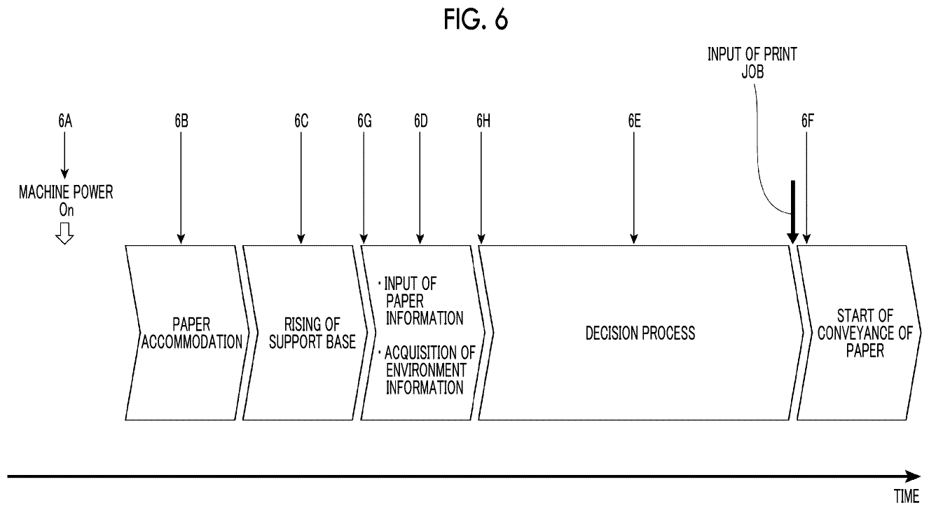

FIG. 6 is a diagram showing an example of a state transition of the image forming apparatus 1.

In this example, first, as indicated by reference numeral 6A, the power of the image forming apparatus 1 is turned on.

Thereafter, in this example, as indicated by reference numeral 6B, the paper P is accommodated in the paper accommodating device 200 by the user.

In a case where the paper P is accommodated in the paper accommodating device 200, first, the opening and closing member 210 shown in FIG. 1 is opened. Then, the paper P is accommodated in the accommodating section 53. Next, the opening and closing member 210 is closed.

In a case where the opening and closing member 210 is closed, as indicated by reference numeral 6C in FIG. 6, the support base 220 rises.

Thereafter, in this example, as indicated by reference numeral 6D, the user inputs paper information which is information regarding the paper P via the receiving unit 70 shown in FIG. 1. The user inputs paper information which is information regarding the basis weight, the size, or the paper type of the paper P accommodated in the paper accommodating device 200.

Additionally, in the present exemplary embodiment, as indicated by reference numeral 6D, environment information, such as a temperature and a humidity, is acquired by a sensor (not shown).

As a result, the CPU 11a acquires the paper information and the environment information.

Next, in this example, as indicated by reference numeral 6E, the CPU 11a starts the decision process shown in FIG. 5. In this case, the CPU 11a starts the decision process in consideration of the acquired paper information and environment information.

In this example, in the first stage of the decision process, the CPU 11a first sets the initial blowing condition at the start of the gas blowing based on the acquired paper information and environment information.

In this case, in step S101 of FIG. 5, the gas blowing is performed onto the paper P in accordance with the initial blowing condition.

Thereafter, the processing of steps S102 to S105 shown in FIG. 5 is executed, and the CPU 11a obtains the above-described blowing setting. Then, the blowing setting is stored in the secondary storage unit 91 shown in FIG. 2, which is a storage unit. As a result, the decision process ends.

Thereafter, in this example shown in FIG. 6, the print job is input to the image forming apparatus 1 at a timing indicated by reference numeral 6F.

In a case where the input of the print job is performed, the CPU 11a reads the blowing setting from the secondary storage unit 91. Then, the CPU 11a controls the blowing device 400 in accordance with the blowing setting.

As a result, the conveyance of the paper P is started in a state in which the gas blowing has been performed based on the blowing setting.

### Change of Start Timing

In the present exemplary embodiment, as described above, the start timing, which is the timing for starting the decision process, may be changed. In this case, the decision process is started at a timing intended by the user.

In FIG. 6, an example has been described in which the start timing for the decision process is a timing after the input of the paper information by the user.

In the present exemplary embodiment, the start timing is changed in response to an instruction from the user.

The user changes the start timing via, for example, the receiving unit 70 shown in FIG. 1.

In the present exemplary embodiment, the user can set the start timing. The user sets a new start timing, for example, by performing an operation on the receiving unit 70.

In the present exemplary embodiment, the user can set a first start timing as the start timing.

The “first start timing” refers to a timing at which the decision process is started in a situation in which the input of the paper information by the user has not yet been performed.

In the present exemplary embodiment, the input of information by the user, that is, the input of the paper information which is the information regarding the paper P to be loaded, is performed.

The first start timing refers to a timing at which the decision process is started in a situation in which the input of the paper information has not yet been performed.

In a case where the first start timing is set as the start timing, for example, the decision process is started in response to the detection that the opening and closing member 210 shown in FIG. 1 has been closed. Alternatively, for example, the decision process is started in response to the detection that the support base 220 has risen.

In this case, the decision process is started in a situation in which the input of the paper information has not yet been performed.

In the present exemplary embodiment, the user can set the first start timing at which the decision process is started in a situation in which the input of the paper information has not yet been performed, as the start timing.

The first start timing can also be said to be a timing at which the decision process is started in response to the detection that the opening and closing member 210 has been closed. In addition, the first start timing can also be said to be a timing at which the decision process is started in response to the rising of the support base 220.

In a case where the user sets the first start timing as the start timing, for example, the decision process is started at a timing indicated by reference numeral 6G in FIG. 6.

In this case, the decision process is started before the user completes the input of the paper information.

In this case, the start of image formation can be performed at an earlier timing as compared with a case where the decision process is started after the input of the print job has been performed to the image forming apparatus 1.

Additionally, in the present exemplary embodiment, a second start timing can be set as the start timing.

The “second start timing” refers to a timing at which the decision process is started after the input of the paper information by the user has been performed. In this case, in a case where the input of the paper information is performed by the user, the decision process is started.

In this case, for example, the decision process is started at a timing indicated by reference numeral 6H in FIG. 6.

In this case, the decision process is started at a timing after the input of the paper information by the user has been completed.

In addition, in this case, as described above, in the first stage of the decision process, the paper information is used, and the initial blowing condition is set. Thereafter, the processing of steps S101 to S105 described above is executed, and the content of the blowing setting is decided on.

Further, the image forming apparatus 1 of the present exemplary embodiment is configured to allow the user to set a third start timing as the start timing.

The “third start timing” refers to a timing at which the decision process is started after the input of the job involving the feeding out of the paper P has been performed. In other words, the third start timing refers to a timing at which the decision process is started after the input of the print job has been performed.

In this case, for example, the decision process is started at the timing indicated by the reference numeral 6F in FIG. 6. In this case, the decision process is started on a condition that the input of the print job has been performed.

Then, in this case, after this decision process has ended, the print job is executed.

In a case where the third start timing is set as the start timing, the decision process is started after the input of the print job has been performed.

Additionally, in this case, the decision process is started in a case where a feeding out process of the paper P included in the print job has not yet been started.

In other words, in this case, the decision process is started at a timing after the input of the print job has been performed and at a timing at which the conveyance of the paper P has not yet been started.

Even in a case where the third start timing is set as the start timing, the paper information is used, and the initial blowing condition is set. Then, under the initial blowing condition, a gas blowing process in the decision process is started.

In a case where the third start timing is set as the start timing, idle time is less likely to occur. Idle time between the end of the decision process and the actual start of the conveyance of the paper P is less likely to occur.

In this case, a state of the paper P in a case where the decision process is performed and a state of the paper P in a case where the conveyance of the paper P is actually started are less likely to differ.

### Setting of Start Timing by User

As an aspect of setting the start timing by the user, for example, an aspect in which the user specifically specifies and inputs information regarding this timing can be mentioned as one example.

As another aspect of setting the start timing by the user, an aspect in which the user selects the start timing from among predetermined candidates can be mentioned as one example. In this case, the user selects a start timing from among a plurality of candidates for the start timing.

In a case of an aspect in which the user selects a start timing from among the predetermined candidates, the CPU 11a causes the receiving unit 70 to display the plurality of candidates for the start timing.

Specifically, the CPU 11a causes the receiving unit 70 to display, for example, three start timings: the first start timing to the third start timing described above.

Then, in this case, the user selects the start timing from among the candidates.

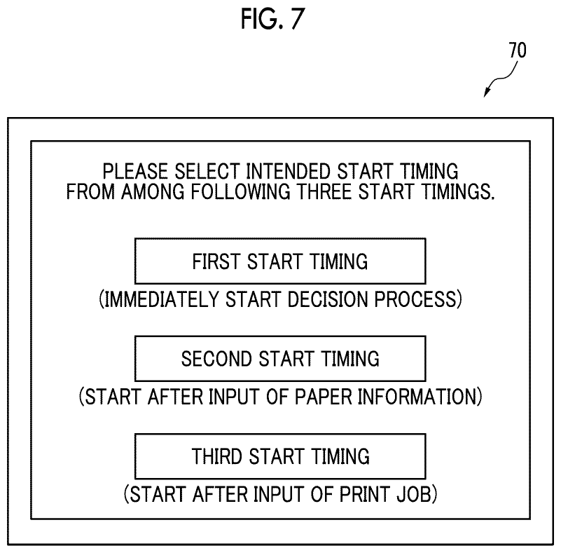

FIG. 7 is a diagram showing a display example of the receiving unit 70.

In a case of an aspect in which the user selects the start timing from among the predetermined candidates, for example, a screen shown in FIG. 7 is displayed on the receiving unit 70.

The plurality of candidates for the start timing are displayed on the screen. Specifically, as the plurality of candidates for the start timing, the first start timing to the third start timing are displayed on the screen.

As described above, the first start timing refers to a start timing at which the decision process is started in a situation in which the input of the paper information by the user has not yet been performed. In this case, the decision process is immediately started upon accommodation of the paper P in the paper accommodating device 200.

As described above, the second start timing refers to a start timing at which the decision process is started after the input of the paper information by the user has been performed.

As described above, the third start timing refers to a start timing at which the decision process is started after the input of the print job has been performed.

The user selects the start timing from among the first start timing to the third start timing. In response to the selection, the CPU 11a acquires information regarding the start timing selected by the user.

### Processing after Decision Process

As another process, in a case where the feeding out of the paper P is not performed before a predetermined time elapses after the above-described decision process has been actually performed, the CPU 11a may cause the decision process to be performed again.

A case is assumed in which the decision process is started at the first start timing and the second start timing described above. In this case, a state in which the feeding out of the paper P is not performed continues in a case where no print job is input even after the decision process has ended.

In a case where the state in which the feeding out of the paper P is not performed continues, the state of the paper P in a case where the decision process is performed and the state of the paper P in a case where the conveyance of the paper P is actually started are likely to differ. In this case, the conveyance of the paper P is likely to deviate from the intended conveyance.

In contrast, as described above, by causing the decision process to be performed again, the state of the paper P in a case where the decision process is performed and the state of the paper P in a case where the conveyance of the paper P is actually started are less likely to differ. In this case, the conveyance of the paper P is less likely to deviate from the intended conveyance.

Additionally, in a case where no instruction to feed out the paper P is issued before a predetermined time elapses after the decision process has been actually performed, the CPU 11a may cause the gas blowing onto the paper P by the blowing device 400 to be performed.

In other words, in a case where no print job is input before a predetermined time elapses after the decision process has been actually performed, the CPU 11a may cause the gas blowing onto the paper P by the blowing device 400 to be performed.

Here, as in the above description, a case is assumed in which the decision process is started at the first start timing and the second start timing. In this case, a state in which the feeding out of the paper P is not performed continues in a case where no print job is input even after the decision process has ended. In this case, re-adhesion between the sheets of paper P or the like is likely to occur.

In this case, in a case where the gas blowing onto the paper P is performed as described above, the adhesion between the sheets of paper P is released. Gas enters between the sheets of paper P, and the adhesion between the sheets of paper P is released.

In this case, the adhesion between the sheets of paper P may be suppressed as compared with a case where a state in which the feeding out of the paper P is not performed continues in a state in which the gas blowing onto the paper P is not performed.

### Processing in Case Where Plurality of Loading Locations are Present

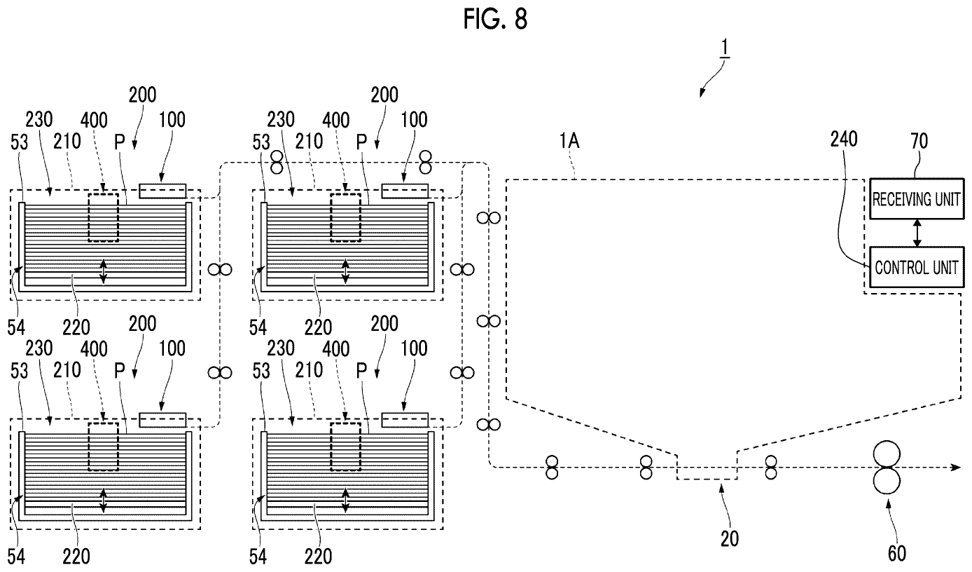

FIG. 8 is a diagram showing another configuration example of the image forming apparatus 1.

In this configuration example, a plurality of paper accommodating devices 200 are provided. In this case, a plurality of loading locations 230, which are locations where the sheets of paper P are loaded, are provided.

The configuration of the image forming section 1A is the same as the configuration of the image forming section 1A shown in FIG. 1. In FIG. 8, the internal configuration of the image forming section 1A is not shown.

In the configuration example shown in FIG. 8, loading locations 230 targeted for feeding out the paper P are sequentially changed. In this configuration example, each time the paper P at the loading location 230 runs out, the loading location 230 is switched to the next scheduled loading location 230.

In this configuration example, in a case where the paper P at the loading location 230 runs out, the loading location 230 is switched to a change destination location which is the next loading location 230 that has been scheduled in advance as a change destination.

In this way, in a case where switching from the loading location 230 where the paper P has run out to the change destination location is performed, the paper P can be supplied to the image forming section 1A without interruption.

In this configuration example, the blowing device 400 is provided for each of the loading locations 230.

In addition, in this configuration example, the above-described decision process is performed for each of the loading locations 230. The CPU 11a provided in the control unit 240 causes the above-described decision process to be performed for each of the loading locations 230.

Further, the image forming apparatus 1 in this configuration example is configured to change the start timing for each of the loading locations 230.

In a case where the user has an intention to change the start timing, as in the above description, the user operates the receiving unit 70 to change the start timing for each of the loading locations 230.

In changing the start timing, the user specifically specifies and inputs information regarding the start timing for each of the loading locations 230. Alternatively, the user selects the start timing from among a plurality of candidates for each of the loading locations 230 and changes the start timing.

Additionally, in the present exemplary embodiment, the user can collectively change the start timings. The user can collectively change the start timings for all of the provided plurality of loading locations 230.

Specifically, in this case, a display for collective change is performed on the receiving unit 70. The user can collectively change the start timings for the plurality of loading locations 230.

The image forming apparatus 1 shown in FIG. 8 is configured to allow the user to set, as the start timing, a timing at which the decision process for the change destination location is started after the actual change to the change destination location has been made.

Hereinafter, this start timing will be referred to as a “fourth start timing”.

In a case where the user sets the fourth start timing, for the change destination location, the decision process for the change destination location is started after switching to the change destination location has been performed.

In this case, as in the case of the third start timing, idle time is less likely to occur. Additionally, in this case, the state of the paper P in a case where the decision process is performed and the state of the paper P in a case where the conveyance of paper P is actually started are less likely to differ.

In addition, in this configuration example, the user can set, as the start timing, a timing at which the decision process for the change destination location is started before the change to the change destination location is made.

Hereinafter, this start timing will be referred to as a “fifth start timing”.

In this case, for the change destination location, the decision process for the change destination location is started before switching to the change destination location is performed.

Specifically, in this case, for example, the decision process for the change destination location is started while the feeding out of the paper P is being performed from another loading location 230 different from the change destination location.

More specifically, in this case, for example, in a case where the loading location 230 immediately preceding the change destination location is serving as the loading location 230 targeted for feeding out the paper P, the decision process for the change destination location is started.

In this case, in a case where the loading location 230 is changed from the immediately preceding loading location 230 to the change destination location, the paper P can be immediately supplied from the change destination location to the image forming section 1A.

On the other hand, in this case, the above-described idle time is likely to occur. In this case, as described above, the state of the paper P in a case where the decision process is performed and the state of the paper P in a case where the conveyance of the paper P is actually started are likely to differ.

Further, in the image forming apparatus 1 shown in FIG. 8, the user can also set a sixth start timing as the start timing.

The “sixth start timing” refers to a timing at which the decision process for the loading location 230 provided with the opening and closing member 210 that has been closed is started in response to the detection that the opening and closing member 210 has been closed.

In this case, in each of the loading locations 230, in response to the detection that the corresponding opening and closing member 210 provided in the loading location 230 has been closed, the decision process for the loading location 230 is started.

In the image forming apparatus 1 shown in FIG. 8, the opening and closing member 210 is provided for each of the loading locations 230. In this configuration example, in a case where the opening and closing member 210 is closed, the decision process for the loading location 230 corresponding to the opening and closing member 210 is started.

Here, the sixth start timing is the same as the above-described first start timing.

As described above, the first start timing is a timing at which the decision process is started in response to the detection that the opening and closing member 210 has been closed.

At the sixth start timing, as described above, each time the opening and closing member 210 is closed, the decision process for the loading location 230 corresponding to the opening and closing member 210 is started.

The present disclosure is not limited thereto, and at the sixth start timing, the decision process for each of the loading locations 230 may be started in response to the detection that all of the opening and closing members 210 have been closed.

In this case, the decision process is not started unless all of the provided plurality of opening and closing members 210 are closed. In response to all of the provided plurality of opening and closing members 210 being closed, the decision process for each of the loading locations 230 is started.

In addition, in the image forming apparatus 1 shown in FIG. 8, as in the above description, the decision process may be started at any start timing of the second start timing or the third start timing.

As described above, the second start timing refers to a timing at which the decision process is started after the input of the paper information by the user has been performed.

The third start timing refers to a start timing at which the decision process is started after the input of the print job has been performed, as described above.

In a case where the start timing is the second start timing, the decision process is started for the loading location 230 for which the input of the paper information has been performed, among the plurality of loading locations 230.

As shown in FIG. 8, in a case where the plurality of loading locations 230 are present, the paper P is typically first accommodated in each of the plurality of loading locations 230.

Next, the user inputs the paper information for each of the plurality of loading locations 230.

In a case where the start timing is the second start timing, the decision process is started sequentially from the loading location 230 for which the input of the paper information has been performed.

In addition, in a case where the input of the paper information has been performed for all of the loading locations 230, the decision process for each of the loading locations 230 may be started.

Additionally, in the image forming apparatus 1 shown in FIG. 8, in a case where the start timing is the third start timing, the decision process is started in response to the input of the print job.

In this case, in a case where the input of the print job is performed, for example, the decision process is started for all of the loading locations 230 after the input of the print job has been performed.

Further, the decision process may be started first only for the loading location 230 where the conveyance of the paper P is first started, instead of all of the loading locations 230. Then, the decision process may be started for the change destination location, which is the loading location 230 serving as the change destination, each time the loading location 230 is changed.

### Others

In the above description, the image forming apparatus 1 in which the image forming section 1A is provided has been described.

The above-described configuration that allows the start timing to be changed can also be applied to an apparatus that does not include the image forming section 1A.

The above-described configuration that allows the start timing to be changed can also be applied to an apparatus that does not include the image forming section 1A and is provided with the paper accommodating device 200 as a core unit. The above-described configuration that allows the start timing to be changed can also be applied to an apparatus having only a paper feeding function.

The apparatus having only the paper feeding function is an apparatus that includes the paper accommodating device 200 and the control unit 240 as core units.

### Supplementary Notes

(((1)))

A recording medium accommodating device comprising:

a feeder configured to feed out a recording medium included in recording media to be loaded;

a gas blower configured to perform gas blowing onto the recording medium in accordance with a predetermined setting in a case where feeding out of the recording medium is performed; and

a processor configured to:
cause a decision process to be performed before the feeding out of the recording medium is started, the decision process being a process for deciding on a content of the setting,

wherein the recording medium accommodating device is configured to change a start timing that is a timing for starting the decision process.

(((2)))

The recording medium accommodating device according to (((1))),

wherein, in the decision process, the gas blowing onto the recording medium by the gas blower is performed, and

with the change of the start timing, a start timing for the gas blowing onto the recording medium by the gas blower is changed.

(((3)))

The recording medium accommodating device according to (((1))) or (((2))),

wherein the start timing is changed in response to an instruction from a user.

(((4)))

The recording medium accommodating device according to any one of (((1))) to (((3))) that is configured to allow a user to select a start timing from among a plurality of candidates for the start timing.

(((5)))

The recording medium accommodating device according to (((4))),

wherein the candidates include a start timing at which the decision process is started in a situation in which input of information by the user has not yet been performed, the input of information being input of information regarding the recording media to be loaded.

(((6)))

The recording medium accommodating device according to (((4))),

wherein the candidates include a start timing at which the decision process is started after input of information by the user has been performed, the input of information being input of information regarding the recording media to be loaded.

(((7)))

The recording medium accommodating device according to (((4))),

wherein the candidates include a start timing at which the decision process is started after input of a job involving the feeding out of the recording medium has been performed.

(((8)))

The recording medium accommodating device according to any one of (((1))) to (((7))) that is configured to allow a user to set the start timing.

(((9)))

The recording medium accommodating device according to (((8))) that is configured to allow the user to set, as the start timing, a timing at which the decision process is started in a situation in which input of information by the user has not yet been performed, the input of information being input of information regarding the recording media to be loaded.

(((10)))

The recording medium accommodating device according to (((8))) that is configured to allow the user to set, as the start timing, a timing at which the decision process is started after input of information by the user has been performed, the input of information being input of information regarding the recording media to be loaded.

(((11)))

The recording medium accommodating device according to (((8))) that is configured to allow the user to set, as the start timing, a timing at which the decision process is started after input of a job involving the feeding out of the recording medium has been performed.

(((12)))

The recording medium accommodating device according to any one of (((1))) to (((11))), wherein the processor is configured to:

cause the decision process to be performed again, in a case where the feeding out of the recording medium is not performed before a predetermined time elapses after the decision process has been performed.

(((13)))

The recording medium accommodating device according to any one of (((1))) to (((11))),

wherein, in the decision process, the gas blowing onto the recording medium by the gas blower is performed,

a state in which the gas blowing onto the recording medium by the gas blower is not performed is maintained from an end of the decision process until an instruction to feed out the recording medium is issued, and

the processor is configured to:
cause the gas blowing onto the recording medium by the gas blower to be performed, in a case where no instruction to feed out the recording medium is issued before a predetermined time elapses after the decision process has been performed.
   (((14)))

The recording medium accommodating device according to any one of (((1))) to (((13))),

wherein a plurality of loading locations that are locations where the recording media are loaded are provided,

the gas blower is provided for each of the loading locations,

the decision process is performed for each of the loading locations, and

the recording medium accommodating device is configured to change the start timing for each of the loading locations.

(((15)))

The recording medium accommodating device according to any one of (((1))) to (((14))),
wherein a plurality of loading locations that are locations where the recording media are loaded are provided,

the gas blower is provided for each of the loading locations,

loading locations targeted for feeding out the recording medium are sequentially changed, and

the recording medium accommodating device is configured to:
allow a user to set the start timing; and
allow the user to set, as the start timing, a timing at which the decision process for a change destination location that is a loading location serving as a change destination is started after a change to the change destination location has been made.
   (((16)))

The recording medium accommodating device according to any one of (((1))) to (((14))),

wherein a plurality of loading locations that are locations where the recording media are loaded are provided,

the gas blower is provided for each of the loading locations,

loading locations targeted for feeding out the recording medium are sequentially changed, and

the recording medium accommodating device is configured to:
allow a user to set the start timing; and
allow the user to set, as the start timing, a timing at which the decision process for a change destination location that is a loading location serving as a change destination is started before a change to the change destination location is made.
   (((17)))

The recording medium accommodating device according to any one of (((1))) to (((14))),

wherein a plurality of loading locations that are locations where the recording media are loaded are provided,

the gas blower is provided for each of the loading locations,

an opening and closing member is provided for each of the loading locations, and

the recording medium accommodating device is configured to:
allow a user to set the start timing; and
allow the user to set, as the start timing, a timing at which the decision process for a loading location provided with the opening and closing member that has been closed is started in response to detection that the opening and closing member has been closed.
   (((18)))

An image forming apparatus comprising:

a feeder configured to feed out a recording medium included in recording media to be loaded;

an image former configured to form an image on the fed-out recording medium;

a gas blower configured to perform gas blowing onto the recording medium in accordance with a predetermined setting in a case where feeding out of the recording medium is performed; and

a processor configured to:
cause a decision process to be performed before the feeding out of the recording medium is started, the decision process being a process for deciding on a content of the setting,

wherein the image forming apparatus is configured to change a start timing that is a timing for starting the decision process.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A recording medium accommodating device comprising:
a feeder configured to feed out a recording medium included in recording media to be loaded;
a gas blower configured to perform gas blowing onto the recording medium in accordance with a predetermined setting in a case where feeding out of the recording medium is performed; and
a processor configured to:
cause a decision process to be performed before the feeding out of the recording medium is started, the decision process being a process for deciding on a content of the setting,
wherein the recording medium accommodating device is configured to change a start timing that is a timing for starting the decision process.

2. The recording medium accommodating device according to claim 1,
wherein, in the decision process, the gas blowing onto the recording medium by the gas blower is performed, and
with the change of the start timing, a start timing for the gas blowing onto the recording medium by the gas blower is changed.

3. The recording medium accommodating device according to claim 1,
wherein the start timing is changed in response to an instruction from a user.

4. The recording medium accommodating device according to claim 1 that is configured to allow a user to select a start timing from among a plurality of candidates for the start timing.

5. The recording medium accommodating device according to claim 4,
wherein the candidates include a start timing at which the decision process is started in a situation in which input of information by the user has not yet been performed, the input of information being input of information regarding the recording media to be loaded.

6. The recording medium accommodating device according to claim 4,
wherein the candidates include a start timing at which the decision process is started after input of information by the user has been performed, the input of information being input of information regarding the recording media to be loaded.

7. The recording medium accommodating device according to claim 4,
wherein the candidates include a start timing at which the decision process is started after input of a job involving the feeding out of the recording medium has been performed.

8. The recording medium accommodating device according to claim 1 that is configured to allow a user to set the start timing.

9. The recording medium accommodating device according to claim 8 that is configured to allow the user to set, as the start timing, a timing at which the decision process is started in a situation in which input of information by the user has not yet been performed, the input of information being input of information regarding the recording media to be loaded.

10. The recording medium accommodating device according to claim 8 that is configured to allow the user to set, as the start timing, a timing at which the decision process is started after input of information by the user has been performed, the input of information being input of information regarding the recording media to be loaded.

11. The recording medium accommodating device according to claim 8 that is configured to allow the user to set, as the start timing, a timing at which the decision process is started after input of a job involving the feeding out of the recording medium has been performed.

12. The recording medium accommodating device according to claim 1, wherein the processor is configured to:
cause the decision process to be performed again, in a case where the feeding out of the recording medium is not performed before a predetermined time elapses after the decision process has been performed.

13. The recording medium accommodating device according to claim 1,
wherein, in the decision process, the gas blowing onto the recording medium by the gas blower is performed,
a state in which the gas blowing onto the recording medium by the gas blower is not performed is maintained from an end of the decision process until an instruction to feed out the recording medium is issued, and
the processor is configured to:
cause the gas blowing onto the recording medium by the gas blower to be performed, in a case where no instruction to feed out the recording medium is issued before a predetermined time elapses after the decision process has been performed.

14. The recording medium accommodating device according to claim 1,
wherein a plurality of loading locations that are locations where the recording media are loaded are provided,
the gas blower is provided for each of the loading locations,
the decision process is performed for each of the loading locations, and
the recording medium accommodating device is configured to change the start timing for each of the loading locations.

15. The recording medium accommodating device according to claim 1,
wherein a plurality of loading locations that are locations where the recording media are loaded are provided,
the gas blower is provided for each of the loading locations,
loading locations targeted for feeding out the recording medium are sequentially changed, and
the recording medium accommodating device is configured to:
allow a user to set the start timing; and
allow the user to set, as the start timing, a timing at which the decision process for a change destination location that is a loading location serving as a change destination is started after a change to the change destination location has been made.

16. The recording medium accommodating device according to claim 1,
wherein a plurality of loading locations that are locations where the recording media are loaded are provided,
the gas blower is provided for each of the loading locations,
loading locations targeted for feeding out the recording medium are sequentially changed, and
the recording medium accommodating device is configured to:
allow a user to set the start timing; and
allow the user to set, as the start timing, a timing at which the decision process for a change destination location that is a loading location serving as a change destination is started before a change to the change destination location is made.

17. The recording medium accommodating device according to claim 1,
wherein a plurality of loading locations that are locations where the recording media are loaded are provided,
the gas blower is provided for each of the loading locations,
an opening and closing member is provided for each of the loading locations, and
the recording medium accommodating device is configured to:
allow a user to set the start timing; and
allow the user to set, as the start timing, a timing at which the decision process for a loading location provided with the opening and closing member that has been closed is started in response to detection that the opening and closing member has been closed.

18. An image forming apparatus comprising:
a feeder configured to feed out a recording medium included in recording media to be loaded;
an image former configured to form an image on the fed-out recording medium;
a gas blower configured to perform gas blowing onto the recording medium in accordance with a predetermined setting in a case where feeding out of the recording medium is performed; and
a processor configured to:
cause a decision process to be performed before the feeding out of the recording medium is started, the decision process being a process for deciding on a content of the setting,
wherein the image forming apparatus is configured to change a start timing that is a timing for starting the decision process.

19. A recording medium accommodating device comprising:
a feeder configured to feed out a recording medium included in recording media to be loaded;
a gas blower configured to perform gas blowing onto the recording medium in accordance with a predetermined setting in a case where feeding out of the recording medium is performed; and
a processor configured to:
cause a decision process to be performed before the feeding out of the recording medium is started, the decision process being a process for deciding on a content of the setting,
wherein the recording medium accommodating device is configured to change a start timing that is a timing for starting the decision process.
